(19) United States
(12) Patent Application Publication
(10) Pub. No.: US 2011/0246659 A1
(43) Pub. Date: Oct. 6, 2011

(54) System, Method and Apparatus for Dynamic Media File Streaming

(75) Inventor: Imed Bouazizi, Tampere (FI)

(73) Assignee: NOKIA CORPORATION, Espoo (FI)

(21) Appl. No.: 12/893,746

(22) Filed: Sep. 29, 2010

Related U.S. Application Data
(60) Provisional application No. 61/246,846, filed on Sep. 29, 2009.

(51) Int. Cl. G06F 15/16

(52) U.S. Cl. 709/231

(57) ABSTRACT

A method, apparatus, system and computer program product are provided to facilitate dynamic media streaming. In this regard, a server may receive a transport protocol for at least the portion of the media file indicating that at least a portion of the media file is to be streamed to a content consumption device requesting the media file. In response, a plurality of fragments to be transmitted to the content consumption device may be determined based upon the transfer protocol request and the plurality of fragments may then be transmitted to the content consumption device in response to the transfer protocol request.

### RELATED APPLICATION

This application claims priority to U.S. Application No. 61/246,846 filed Sep. 29, 2009, which is incorporated herein by reference in its entirety.

### TECHNOLOGICAL FIELD

Embodiments of the present invention relate generally to communications technology and, more particularly, relate to a system, method and apparatus for media file streaming.

### BACKGROUND

Networking technologies and the computing devices that make use of the networking technology have evolved in such a manner as to continue to facilitate the ease of information transfer and convenience to users. In this regard, the expansion of networks and the evolution of network computing devices have provided sufficient processing power, storage space and network bandwidth to enable the transfer and playback of increasingly complex digital media files. Accordingly, internet television, video sharing and the like are gaining in popularity.

In order to facilitate the transfer and playback of digital media files, digital media files may be streamed from a server to a content consumption device, such as a computing device. Media file streaming may be accommodated by fragmenting a media file into a plurality of fragments. The content consumption device may request a fragment of a media file and the server may then transmit the fragment to the content consumption device in response to the request. Following the transmission and receipt of one fragment, the client consumption device may request another fragment from the server. This process may be repeated with the media file being transmitted from the server to the content consumption device one fragment at a time.

### BRIEF SUMMARY OF SOME EXAMPLES OF THE INVENTION

A system, method, apparatus and computer program product are therefore provided according to one example embodiment for facilitating the streaming of media files using a transport protocol, such as hypertext transport protocol (HTTP). In one embodiment, a client consumption device may issue a transport protocol request that causes a server to transmit multiple fragments of a media file. By transmitting multiple fragments in response to a transport protocol request, the media file may be streamed in a more efficient manner with a lower request overhead and a greater percentage of the data transmitted between the server and the content consumption device being dedicated to the content itself. In order to further increase the efficiency of the streaming process, a transport protocol request may be issued that identifies two or more different types of tracks such that a plurality of fragments of each of the two or more different kinds of tracks may be provided in response to the transport protocol request. Additionally, the transmission of multiple fragments in response to a single transport protocol request may permit the bitrate to be more smoothly adapted over the course of streaming a media file in correspondence with the quality of the network conditions, such that any changes in the bitrate are disconcerting to the viewer. Moreover, by permitting the transport protocol request to identify a portion of a media file to be downloaded without having to specify a particular fragment to be downloaded, the server need not initially provide an index file of available fragments and, as such, may generate the fragments dynamically in response to the transport protocol request.

In one embodiment, a method is provided, which includes receiving a transport protocol request for at least the portion of the media file indicating that at least a portion of the media file is to be streamed to a content consumption device requesting the media file. The method of this embodiment also determines a plurality of fragments to be transmitted to the content consumption device based upon the transfer protocol request and then provides for transmission of the plurality of fragments to the content consumption device in response to the transfer protocol request.

In another embodiment a computer program product is provided. The computer program product includes at least one computer-readable storage medium having computer-readable program instructions stored therein. The computer-readable program instructions of this embodiment may include program instructions which when executed by a server are configured to receive a transport protocol request for at least the portion of the media file indicating that at least a portion of the media file is to be streamed to a content consumption device requesting the media file. The computer-readable program instructions of this embodiment, when executed, are also configured to cause the server to determine a plurality of fragments to be transmitted to the content consumption device based upon the transfer protocol request and to then provide for transmission of the plurality of fragments to the content consumption device in response to the transfer protocol request.

In a further embodiment, an apparatus is provided. The apparatus of this embodiment includes at least one processor and at least one memory storing computer program code. The at least one memory storing computer program code is configured to, working with the at least one processor, cause the apparatus to receive a transport protocol request for at least the portion of the media file indicating that at least a portion of the media file is to be streamed to a content consumption device requesting the media file. The apparatus of this embodiment is also caused to determine a plurality of fragments to be transmitted to the content consumption device based upon the transfer protocol request and to then provide for transmission of the plurality of fragments to the content consumption device in response to the transfer protocol request.

In yet another embodiment, an apparatus is provided that includes means for receiving a transport protocol request for at least the portion of the media file indicating that at least a portion of the media file is to be streamed to a content consumption device requesting the media file. The apparatus of this embodiment also includes means for determining a plurality of fragments to be transmitted to the content consumption device based upon the transfer protocol request and means for providing for transmission of the plurality of fragments to the content consumption device in response to the transfer protocol request.

In another embodiment, a method is provided, which includes directing issuance of a transfer protocol request for at least a portion of the media file indicating that at least a portion of the media file is to be streamed from a server. A method of this embodiment also comprises receiving a plurality of fragments from the server in response to the transfer protocol request.

In another embodiment a computer program product is provided. The computer program product includes at least one computer-readable storage medium having computer-readable program instructions stored therein. The computer-readable program instructions of this embodiment may include program instructions which, when executed by a processor, are configured to direct issuance of a transfer protocol request for at least a portion of the media file indicating that at least a portion of the media file is to be streamed from a server. The computer-readable program instructions of this embodiment are also configured, when executed by a processor, to cause a communication device to receive a plurality of fragments from the server in response to the transfer protocol request.

In a further embodiment, an apparatus is provided. The apparatus of this embodiment includes at least one processor and at least one memory storing computer program code. The at least one memory storing computer program code is configured to, working with the at least one processor, cause the apparatus to direct issuance of a transfer protocol request for at least a portion of the media file indicating that at least a portion of the media file is to be streamed from a server. The apparatus of this embodiment is also caused to receive a plurality of fragments from the server in response to the transfer protocol request.

In yet another embodiment, an apparatus is provided that includes means for directing issuance of a transfer protocol request for at least a portion of the media file indicating that at least a portion of the media file is to be streamed from a server. The apparatus of this embodiment also includes means for receiving a plurality of fragments from the server in response to the transfer protocol request.

In a further embodiment, a system is provided that includes a server and a content consumption device configured to support media file streaming from the server to the content consumption device. In this embodiment, the content consumption device is configured to direct issuance of a transfer protocol request for at least a portion of the media file indicating that at least a portion of the media file is to be streamed from a server and to receive a plurality of fragments from the server in response to the transfer protocol request. In addition, the server in this embodiment is configured to receive a transport protocol for at least the portion of the media file indicating that at least a portion of the media file is to be streamed to a content consumption device requesting the media file. The server of this embodiment is also configured to determine a plurality of fragments to be transmitted to the content consumption device based upon the transfer protocol request and to then provide for transmission of the plurality of fragments to the content consumption device in response to the transfer protocol request.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for facilitating streaming of media files using a transfer protocol according to an exemplary embodiment of the present invention;

FIG. 2 is a schematic block diagram of a mobile terminal according to an exemplary embodiment of the present invention;

FIG. 3 is a flowchart according to an exemplary method for facilitating streaming of media files in accordance with one example embodiment of the invention;

FIG. 4 illustrates ISOFF-compliant structured media content that may be formatted in accordance with one example embodiment of the invention; and

FIGS. 5-8 illustrate additional flowcharts according to exemplary methods for facilitating streaming of media files according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, it should be appreciated that many other potential embodiments of the invention, in addition to those illustrated and described herein, may be embodied in many different forms. Embodiments of the present invention should not be construed as limited to the embodiments set forth herein; rather, the embodiments set forth herein are provided so that this disclosure will satisfy applicable legal requirements. Like reference numerals refer to like elements throughout.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Some multimedia servers use real-time transport protocol (RTP) over user datagram protocol (UDP) for media streaming (together with the real-time streaming protocol (RTSP) as a control protocol). In this regard, UDP provides basic transport functionality such as application addressing and corruption detection. RTP complements UDP with media transport relevant functionality, such as loss detection, packet re-ordering, synchronization, statistical data collection, and session participant identification. However, RTP over UDP (RTP/UDP) does not provide built-in congestion control and/or error correction functionality. RTP/UDP may gather sufficient information for implementing congestion control and/or error correction functionality on a need basis at an application level. However, with the rising popularity of mobile and internet video, it is becoming even a greater priority to maintain good network behavior through appropriate rate control mechanisms. Additionally, in RTP/UDP-based streaming applications, the sender and/or receiver of the streaming media, if not appropriately configured, may fail to traverse network address translation (NAT) device(s) and/or a firewall(s) positioned in the streaming path between the sender and receiver.

Hypertext transfer protocol (HTTP) streaming media delivery is replacing RTSP/RTP-based streaming in some applications. Even though HTTP was not designed for the delivery of real-time media, HTTP provides benefits that make it attractive for streaming media content delivery applications. In this regard, HTTP is relatively easy to setup and deploy. Additionally, HTTP media delivery overcomes NAT and firewall traversal issues that hinder use of RTSP/RTP-based streaming. Further, HTTP is widely deployed with a very robust infrastructure (such as HTTP caches) that enables efficient data distribution.

HTTP is an application-level transfer protocol that was developed for the delivery of hyperlinked text documents. The usages of the protocol have evolved further to cover the delivery of files of different types of files and data. HTTP uses a request/response model to retrieve remote resources from a web server. The client establishes a transport protocol connection (e.g., a transmission control protocol (TCP) connection) with the server, typically on port 80, and exchanges HTTP messages with the server. An HTTP message may comprise a header portion and an optional body portion. The header portion may comprise a sequence of HTTP header fields, each ending with a carriage return/line feed character. The HTTP message header may be separated from the HTTP message body by an empty line. The HTTP header fields are provided in a human-readable textual format. A Uniform Resource Locator (URL) or Uniform Resource Identifier (URI) is used to identify and locate the resource that is to be retrieved by the HTTP client. A URI comprises a protocol identifier, a fully qualified domain name, a path to the requested resource, and optionally a query string.

However, media streaming over HTTP is still not as efficient as desired due, for example, to the relatively high request overhead. In this regard, prior to streaming media, a content consumption device usually fetches an index file from the server. The index file includes a listing of one or more identifiers associated with all content fragments of a media file.

Since the content fragments are relatively short, such as two to four seconds, in comparison to the overall length of the media file, the index file may be sizeable and its transmission to the content consumption device may consume more bandwidth than is desired, particularly since the index file may generally be updated and re-transmitted on a fairly frequent basis, e.g., for live content. Moreover, the index file is generally provided in the form of an extensible markup language (XML) document that must first be parsed and processed by the content consumption device. The parsing of the index file may also consume more time and resources than is desired and may also undesirably increase the overhead associated with media file streaming. An additional issue associated with the advanced provision of an index file listing identifiers associated with all content fragments is that the provision of the index file presupposes that the media file has already been formatted into fragments. With respect to some types of media files, however, such as media files that capture live or ongoing events, such as a sporting event or a live musical performance, or on-demand media files, the media file may not be formatted into fragments in advance and, indeed, may not be in existence at the time at which the index file is compiled.

Following the transmission of the index file from the server to the content consumption device, the content consumption device may issue a request for a particular fragment of the media file. The server may then provide the requested fragment of the media file and only after receipt of the fragment by the content consumption device may the content consumption device request another fragment of the media file. This process by which the media file is requested and delivered on a fragment-by-fragment basis may then be repeated numerous times until the desired portion of the media file has been transmitted to the content consumption device. The repeated request for a fragment of the media file undesirously increases the overhead associated with the media file streaming. Additionally, since the content consumption device must await receipt of the immediately preceding fragment prior to issuing a request for the next fragment over the same TCP connection, a delay may be injected into the media file streaming process in instances in which one of the fragments is misdirected or otherwise fails to be timely received by the content consumption device. The delay in receiving a data fragment may result in an interruption in the playback of the media content at the content consumption device.

The fragments of a media file may be available from a server at a plurality of different bitrates. Based upon the network conditions, a content consumption device may therefore tailor its request, for example, by requesting a fragment from a low bitrate track of the media content in order to adjust to a decrease in available network bandwidth. If an improvement in network bandwidth or network conditions is detected, the content consumption device may request a fragment from a high bitrate track of the media content. In this instance, a content consumption device that detects relatively poor network conditions, such as relatively low bandwidth, may request a fragment having a lower bitrate and therefore a reduced quality, while a content consumption device that detects improved network conditions, such as greater bandwidth, may request a fragment having a greater bitrate and therefore improved quality. The determination of the network conditions is generally performed by the content consumption device on a request-by-request basis. Since each request is for a single fragment, however, the content consumption device may not be provided with a sufficient duration in which to gauge the current network conditions. Moreover, since the bitrate and, therefore, the quality of the fragments may change with every fragment, such as every two to four seconds, the resulting changes in the quality of the display may be disconcerting for the viewer.

A media file may include a plurality of different tracks. As described above, a media file may include different tracks of the same type, such as video tracks, but at different bitrates, thereby facilitating bitrate adaptation in response to the current network conditions. By way of example of the different types of tracks, the media file may include video tracks, audio tracks and subtitle tracks for the same media file. Conventionally, a content consumption device would separately have to issue a request for a fragment from each different type of track, such as one request for an audio track fragment, another request for a video track fragment, and yet another request for a subtitle track fragment. Since each request must be issued in a serial fashion, the necessity to issue separate requests for the different types of tracks further increases the request overhead and reduces the efficiency of the media file streaming process.

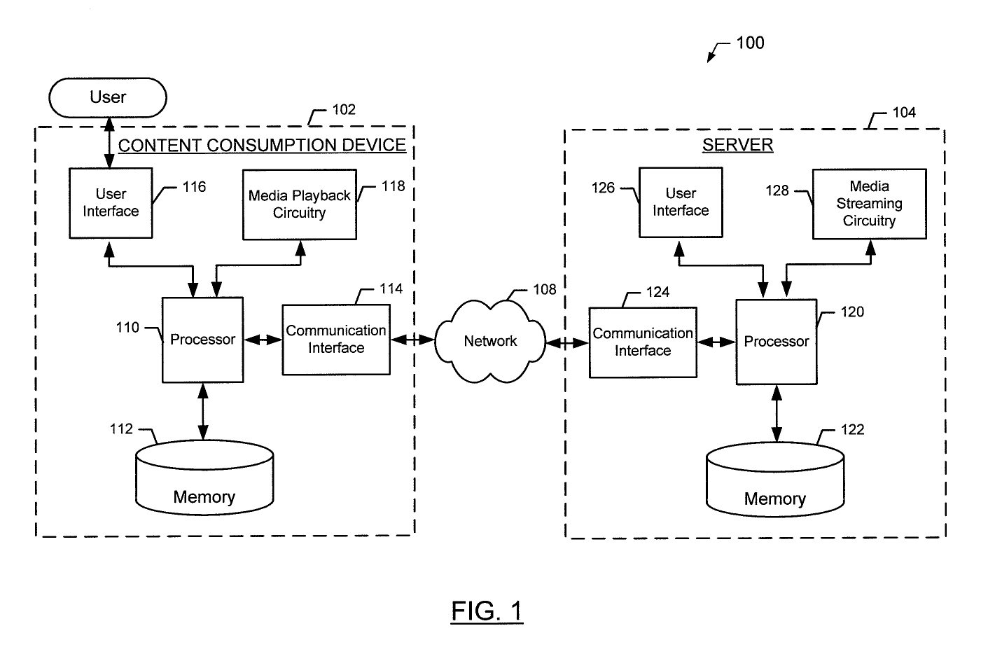

Accordingly, embodiments of the invention provide systems, methods, apparatuses, and computer program products that may address some of the deficiencies of conventional media streaming techniques. For example, in order to reduce request overhead and increase the efficiency of a media file streaming process as well as to provide other advantages, a system, apparatus, method and computer program product are provided according to embodiments of the present invention that permit multiple fragments to be transmitted from a server to a content consumption device in response to a single transfer protocol request. In this regard, FIG. 1 illustrates a block diagram of a system 100 for facilitating streaming of media files according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for facilitating streaming of media files, numerous other configurations may also be used to implement embodiments of the present invention. Further, it should be appreciated that hypertext transfer protocol (HTTP) is used as an example of an application layer transfer protocol that may be used for streaming of media files in accordance with some embodiments of the invention. Other embodiments of the invention are configured to stream media files using other application layer transfer protocols in addition to or in lieu of HTTP.

FIG. 1 illustrates a block diagram of a system 100 for streaming media files using an application layer transfer protocol, such as hypertext transfer protocol (HTTP), according to an example embodiment of the present invention. In an example embodiment, the system 100 comprises a content consumption device 102 and a server 104. The content consumption device 102 and the server 104 are configured to communicate over a network 108. The network 108, for example, comprises one or more wireline networks, one or more wireless networks, or some combination thereof. The network 108 may comprise a public land mobile network (PLMN) operated by a network operator. In this regard, the network 108, for example, comprises an operator network providing cellular network access, such as in accordance with 3GPP standards. The network 108 may additionally or alternatively comprise the internet.

The content consumption device 102 may comprise any device configured to access content from a server 104 over the network 108. For example, the content consumption device 102 comprises a server, a desktop computer, a laptop computer, a mobile terminal, a mobile computer, a mobile phone, a mobile communication device, a game device, a digital camera/camcorder, an audio/video player, a television device, a radio receiver, a digital video recorder, a positioning device, any combination thereof, and/or the like.

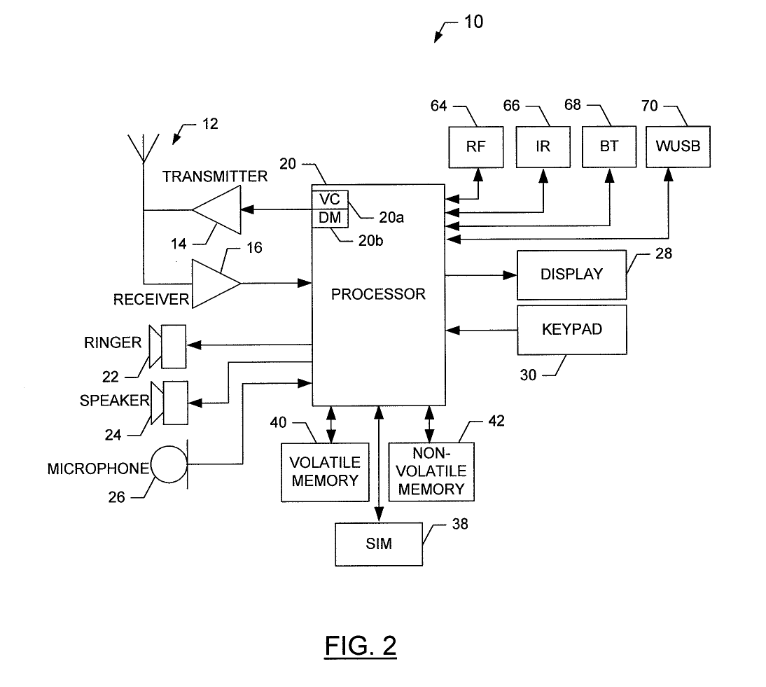

In an example embodiment, the content consumption device 102 is embodied as a mobile terminal, such as that illustrated in FIG. 2. In this regard, FIG. 2 illustrates a block diagram of a mobile terminal 10 representative of one embodiment of a content consumption device 102 in accordance with embodiments of the present invention. It should be understood, however, that the mobile terminal 10 illustrated and hereinafter described is merely illustrative of one type of content consumption device 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a processor 20 that provides signals to and receives signals from the transmitter and receiver, respectively. These signals may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits, such as, for example, an ASIC (application specific integrated circuit) or FPGA (field programmable gate array), or some combination thereof. The processor may additionally comprise an internal voice coder (VC) 20a, an internal data modem (DM) 20b, and/or the like. Further, the processor may comprise functionality to operate one or more software programs, which may be stored in memory. For example, the processor may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Referring again to FIG. 1, in an example embodiment, the client consumption device 102 comprises various means, such as a processor 110, a memory 112, a communication interface 114, a user interface 116, and a media playback circuitry 118, for performing the various functions herein described. The various means of the client device 102 as described herein comprise, for example, hardware elements, e.g., a suitably programmed processor, combinational logic circuit, and/or the like, a computer program product comprising computer-readable program instructions, e.g., software and/or firmware, stored on a computer-readable medium, e.g. memory 112. The program instructions are executable by a processing device, e.g., the processor 110.

The processor 110 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an application specific integrated circuit (ASIC) or a field programmable gate array (FPGA), or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the content consumption device 102 as described herein. In embodiments wherein the content consumption device 102 is embodied as a mobile terminal 10, the processor 110 may be embodied as or otherwise comprise the processor 20. In an example embodiment, the processor 110 is configured to execute instructions stored in the memory 112 or otherwise accessible to the processor 110. The instructions, when executed by the processor 110, cause the content consumption device 102 to perform one or more of the functionalities of the content consumption device 102 as described herein. As such, whether configured by hardware or software operations, or by a combination thereof, the processor 110 may represent an entity capable of performing operations according to embodiments of the present invention when configured accordingly. For example, when the processor 110 is embodied as an ASIC, FPGA or the like, the processor 110 may comprise specifically configured hardware for conducting one or more operations described herein. Alternatively, as another example, when the processor 110 is embodied as an executor of instructions, the instructions may specifically configure the processor 110, which may otherwise be a general purpose processing element if not for the specific configuration provided by the instructions, to perform one or more operations described herein.

The memory 112 may include, for example, volatile and/or non-volatile memory. Although illustrated in FIG. 1 as a single memory, the memory 112 may comprise a plurality of memories. The memory 112 may comprise volatile memory, non-volatile memory, or some combination thereof. In this regard, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments in which the content consumption device 102 is embodied as a mobile terminal, the memory 112 may be embodied as or otherwise comprise the volatile memory 40 and/or non-volatile memory 42. The memory 112 may be configured to store information, data, applications, instructions, or the like for enabling the content consumption device 102 to carry out various functions in accordance with embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by the media playback unit 118 during the course of performing its functionalities.

The communication interface 114 may be embodied as any device or means embodied in hardware, a computer program product comprising computer readable program instructions stored on a computer readable medium (e.g., the memory 112) and executed by a processing device (e.g., the processor 110), or a combination thereof that is configured to receive and/or transmit data from/to a remote device over the network 108. In at least one embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with other entities of the system 100, e.g., antenna 12, transmitter 14 and/or receiver 16 of mobile terminal 10 of FIG. 2. The communication interface 114 may be configured to receive and/or transmit data using any protocol that may be used for communications between computing devices of the system 100. The communication interface 114 may additionally be in communication with the memory 112, user interface 116, and/or media playback circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms, e.g., earphone or speaker 24, microphone 26, display 28 and/or keypad 30 of mobile terminal 10 of FIG. 2. The user interface 116 may provide an interface allowing a user to select a media file and/or media tracks thereof to be streamed from the server 104 to the content consumption device 102 for playback on the content consumption device 102. In this regard, video from a media file may be displayed on a display of the user interface 116 and audio from a media file may be audibilized over a speaker of the user interface 116. The user interface 116 may be in communication with the memory 112, communication interface 114, and/or media playback circuitry 118, such as via a bus.

The media playback circuitry 118 may be embodied as various means, such as hardware, a computer program product comprising computer readable program instructions stored on a computer readable medium (e.g., the memory 112) and executed by a processing device (e.g., the processor 110), or some combination thereof and, in one embodiment, is embodied as or otherwise controlled by the processor 110. In embodiments where the media playback circuitry 118 is embodied separately from the processor 110, the media playback circuitry 118 may be in communication with the processor 110. The media playback circuitry 118 may further be in communication with the memory 112, communication interface 114, and/or user interface 116, such as via a bus.

The server 104 may comprise one or more computing devices configured to provide media files to a content consumption device 102. In at least one embodiment, the server 104 comprises one or more servers, such as an HTTP server, a dynamic streaming server, a content provider server, a web server, a network server or the like. While the server 104 may be the source of the media files, the server may also be an intermediary for receiving the media files from one or more content sources and for providing the media files to the content consumption device 102. In an exemplary embodiment, the server 104 includes various means, such as a processor 120, memory 122, communication interface 124, user interface 126, and media streaming circuitry 128 for performing the various functions herein described. These means of the server 104 as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be embodied on a single computing device or distributed across a plurality of computing devices. The plurality of processors may be in operative communication with each other and may be collectively configured to perform one or more functionalities of the server 104 as described herein. In an exemplary embodiment, the processor 120 is configured to execute instructions stored in the memory 122 or otherwise accessible to the processor 120. These instructions, when executed by the processor 120, may cause the server 104 to perform one or more of the functionalities of server 104 as described herein. As such, whether configured by hardware or software methods, or by a combination thereof, the processor 120 may represent an entity capable of performing operations according to embodiments of the present invention when configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, the instructions may specifically configure the processor 120, which may otherwise be a general purpose processing element if not for the specific configuration provided by the instructions, to perform one or more algorithms and operations described herein.

The memory 122 may include, for example, volatile and/or non-volatile memory. Although illustrated in FIG. 1 as a single memory, the memory 122 may comprise a plurality of memories, which may be embodied on a single computing device or distributed across a plurality of computing devices. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the media content source 104 to carry out various functions in accordance with embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the media streaming unit 128 during the course of performing its functionalities.

The communication interface 124 may be embodied as any device or means embodied in hardware, a computer program product comprising computer readable program instructions stored on a computer readable medium, e.g., the memory 122, and executed by a processing device, e.g., the processor 120, or a combination thereof that is configured to receive and/or transmit data from/to a remote device over the network 108. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with other entities of the system 100. The communication interface 124 may be configured to receive and/or transmit data using any protocol that may be used for communications between computing devices of the system 100. The communication interface 124 may additionally be in communication with the memory 122, user interface 126, and/or media streaming circuitry 128, such as via a bus.

The user interface 126 may be in communication with the processor 120 to receive an indication of a user input and/or to provide an audible, visual, mechanical, or other output to the user. As such, the user interface 126 may include, for example, a keyboard, a mouse, a joystick, a display, a touch screen display, a microphone, a speaker, and/or other input/output mechanisms. In embodiments wherein the server 104 is embodied as one or more servers, the user interface 126 may be limited, or even eliminated. The user interface 126 may be in communication with the memory 122, communication interface 124, and/or media streaming circuitry 128, such as via a bus.

The media streaming circuitry 128 may be embodied as various means, such as hardware, a computer program product comprising computer readable program instructions stored on a computer readable medium, e.g., the memory 122, and executed by a processing device, e.g., the processor 120, or some combination thereof and, in one embodiment, is embodied as or otherwise controlled by the processor 120. In embodiments wherein the media streaming circuitry 128 is embodied separately from the processor 120, the media streaming circuitry 128 may be in communication with the processor 120. The media streaming circuitry 128 may further be in communication with the memory 122, communication interface 124, and/or user interface 126, such as via a bus.

In an example embodiment, the media playback circuitry 118 is configured to send a transfer protocol request for a media file to the server 104. In an example embodiment, the requested media file comprises a media file compliant with the ISO base media file format. Examples of an ISO base media file format comprise a 3GP media file and a moving picture experts group 4 (MPEG-4) Part 14 (MP4) file. The request, for example, is sent in response to a user input or request received via the user interface 116.

The transfer protocol request comprises an indication that the media file is to be streamed to the content consumption device 102. In an example embodiment, the transfer protocol request comprises an HTTP GET request. The HTTP GET request comprises a header field including a token indicating that the media file is to be streamed. For example, the header field may comprise the “Expect” header field and include a token, e.g. “http-streaming”, defined to indicate that the server 104 is required to support HTTP streaming of media files, such as 3GPP based HTTP streaming of a 3GP media file. In another example, the header field comprises the “Pragma” header field and includes a token, e.g. “http-streaming”, defined to indicate that the server 104 is being queried for support of HTTP streaming of the requested media file.

In an example embodiment, the media streaming circuitry 128 is configured to receive a transfer protocol request sent by the content consumption device 102. If the transfer protocol request includes an indication that the requested media file is to be streamed to the content consumption device 102 and the server 104 is not configured to stream a media file, the media streaming circuitry 128 is configured to send an error message to the content consumption device 102. If the server 104 is configured to stream a media file then the media streaming circuitry 128 is configured to include support in a reply message sent to the content consumption device 102. Such support may, for example, be indicated as part of the Pragma header field of a HTTP reply message.

In an example embodiment, the media streaming circuitry 128 is further configured to, in response to receipt of a transfer protocol request for a media file, access the requested media file from the memory 122 or other memory accessible to the server 104. The media streaming circuitry 128 is configured to extract at least a portion of information associated with media data in the media file. In an example embodiment, the extracted portion of information(s) comprises a portion(s) of the metadata associated with media data in the media file. For example, the extracted portion of metadata comprises general information about the content of the media file, e.g., the type(s) of media data and/or the different tracks in the media file. The extracted portion(s) of metadata comprises, for example, only information useful to the content consumption device to select at least one track from the media file.

The metadata associated with the media file, for example, may be structured in accordance with the International Organization for Standardization (ISO)-base media File Format (ISOFF) as outlined in the table below:

| 0 | 1 | 2 | 3 | 4 | 5 | Description |
|---|---|---|---|---|---|---|
| typ | | | | | | File type and compatibility |
| oov | | | | | | Container for all metadata |
| | vhd | | | | | Movie header, overall declarations |
| | rak | | | | | Container for an individual trak or stream |
| | | khd | | | | Track header, overall information in a track |
| | | ref | | | | Track reference container |
| | | dia | | | | Container for media information in a track |
| | | | dhd | | | Media header, overall information about the |
| | | | | | | media |
| | | | dlr | | | Handler, declares the media type |
| | | | inf | | | Media information container |
| | | | | mhd | | Video media header, overall information for |
| | | | | | | video track only |
| | | | | mhd | | Sound media header, overall information for |
| | | | | | | sound track only |
| | | | | tbl | | Sample table box, container for the |
| | | | | | | time/space map |
| | | | | | tsd | Sample descriptions for the initialization of |
| | | | | | | the media decoder |
| | | | | | tts | Decoding time-to-sample |
| | | | | | tts | Composition time-to-sample |
| | | | | | tsc | Sample-to-chunk |
| | | | | | tsz | Sample sizes |
| | | | | | tco | Chunk offset to beginning of the file |
| | | | | | tss | sync sample table for Random Access Points |
| oof | | | | | | Movie fragment |
| | fhd | | | | | Movie fragment header |
| | raf | | | | | Track fragment |
| | | fhd | | | | Track fragment header |
| | | run | | | | Track fragment run |
| fra | | | | | | Movie fragment random access |
| | fra | | | | | Track fragment random access |
| | fro | | | | | Movie fragment random access offset |
| dat | | | | | | Media data container |

The IS OFF is designed in an object-oriented manner. In this regard, an IS OFF compliant file is composed of a set of boxes that may be inherited and extended through the definition of new boxes. All information in an IS OFF-compliant file must be contained in a box. A box may itself contain other boxes. Each box is identified by a unique type, which is typically defined as a 4 byte type (4 characters). Each box also indicates the length of the box, including the header of the box. These two fields are defined by the “Box” box, which is inherited by all ISOFF boxes.

As illustrated above, ISOFF-compliant data comprises a hierarchy of a plurality of levels of metadata. Each level comprises one or more sublevels including more specific metadata related to the parent level. For example, a first level, “L0” comprises the metadata categories ftyp, moov, moof, mfra, and mdat. Ftyp and mdat may not include any sublevels. The second level, “L1” of moov may comprise, for example, mvhd and trak. The third level, “L2” of trak, for example, comprises tkhd, tref, and mdia. The fourth level, “L3” of mdia may, for example, comprise mdhd, hdlr, and minf. The fifth level, “L4” of minf may comprise vmhd, smhd, and stbl. The sixth level, “L5,” of stbl may, for example, comprise stsd, stts, ctts, stsc, stsz, stco, and stss. Accordingly, the above table represents a nested hierarchy of blocks of metadata, wherein sublevels of a block of metadata are illustrated in rows below the row including the corresponding parent metadata block and in columns to the right of the column including the corresponding parent block of metadata. Thus, all sublevels of blocks of metadata of the moov block are shown in the rows of the table below the row including the moov block until reaching the row including the “moof” block, e.g., another parent block of metadata, which is on the same level as the moov block. Similarly, all sublevels of blocks of metadata of the stbl block are shown in the rows of the table below the row including the stbl block, until reaching the row including the moof block, which is the first block at a level the same as or higher than the stbl block.

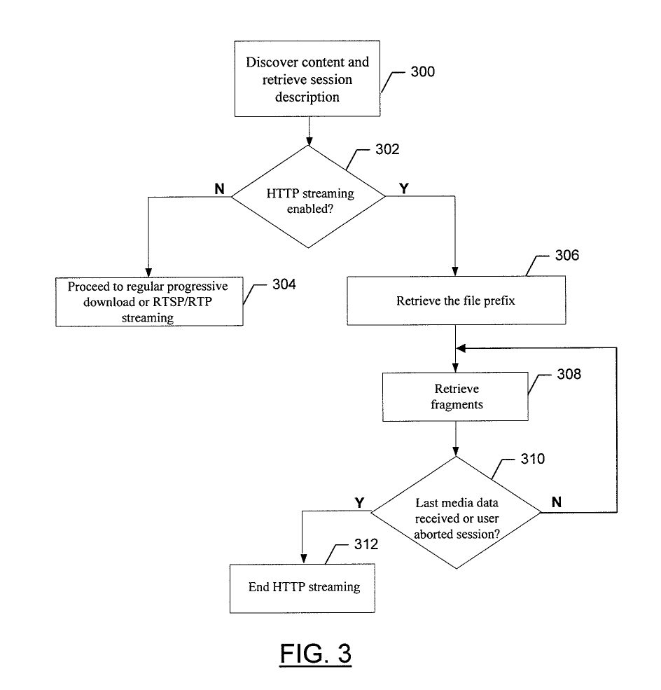

Prior to streaming content from the server 104 to the content consumption device 102 as generally represented by FIG. 3 which depicts operations that may be performed at and/or by the content consumption device 102, such as by and/or under the control the media playback circuitry 118, the content consumption device 102 may request and be provided with session or content description information. See operation 300 of FIG. 3. In one embodiment, the server 104 is configured to provide content via several different streaming protocols, such as RTSP/RTP streaming, HTTP streaming or the like. Thus, the content consumption device 102 may be provided with information regarding the delivery methods supported by the server 104, e.g., the various streaming options, in session description information provided by the server 104 to the content consumption device 104 using session description protocol (SDP), via a web portal that is provided by the server 104 and accessed by the content consumption device 102 to discover the available content or the like.

In instances in which the server 104 provides information regarding the possible delivery options using SDP, the SDP may be extended with elements that indicate whether or not the content is available via HTTP streaming. The SDP may also contain a description of all of available media components of the content. The content consumption device 102 may then utilize the description of the available media components in selecting the appropriate content components to be streamed, such as via HTTP. By way of example, the content components that may be streamed over HTTP may include different types of tracks, such as video tracks, audio tracks, sub-title tracks and/or the like. For a particular type of track, such as a video or an audio track, the available media content may also include content at different bit rates in order to support bit rate adaptation as described below based upon, for example, the network conditions at the time of streaming. By way of example, the SDP extensions that may be utilized by a server 104 and a corresponding content consumption device 102 to describe the media components available via HTTP streaming for an example media file may be as follows:

v=0

o=− 950814089 950814089 IN IP4 144.132.134.67
s=Example of content available via HTTP Streaming
e=user@nokia.com
c=IN IP4 0.0.0.0
b=AS:600

b=TIAS:500000

t=0 0
a=maxprate:100

a=range:npt=0-7200
a=httpstreaming: 1

a=control: http://www.nokia.com/content/example.3gp

m=audio 0 HTTP/TCP *

b=AS:80

b=TIAS:64000

a=maxprate:20

a=control: trackID=1

a=lang:en

m=audio 0 HTTP/TCP *

b=AS:80

b=TIAS:64000

a=maxprate:20

a=control: trackID=2

a=lang:fr

m=audio 0 HTTP/TCP *

b=AS:80

b=TIAS:64000

a=maxprate:20

a=control: trackID=3

a=lang:de

m=audio 0 HTTP/TCP *

b=AS:80

b=TIAS:64000

a=maxprate:20

a=control: trackID=4

a=lang:ar

m=video 0 HTTP/TCP *

b=AS:520

b=TIAS:450000

a=maxprate:80
a=control: trackID=5

m=video 0 HTTP/TCP *

b=AS:400

b=TIAS:350000

a=maxprate:80
a=control: trackID=6

m=video 0 HTTP/TCP *

b=AS:300

b=TIAS:250000

a=maxprate:80
a=control: trackID=7

As illustrated in the foregoing example, the available audio components include audio components in different languages, while the video components that are available include video components that are coded at different bit rates. In the foregoing example, the “a=control” attribute at the session level may include an identifier of the content, such as an HTTP URL to the content file. In the foregoing example, the HTTP URL is HTTP:/www.nokia.com/content/example.3gp. The content file may exist physically at the server 104 or may represent a virtual file. In contrast, the “a=control” attribute at the media level may include an identifier of the track in which the particular media component is stored, e.g., track ID=1, track ID=2, etc. The track ID may be utilized at the media level and the content streamed over HTTP may preserve the track ID mapping.

Based upon the session description information, the client consumption device 102 may determine if HTTP streaming is enabled as shown at operation 302 of FIG. 3 and, if not, may proceed to download the content in another manner, such as by progressive downloading and/or RTSP/RTP streaming as shown at operation 304 of FIG. 3. If HTTP streaming is enabled, however, the client consumption device 102 may issue a transfer protocol request for at least a portion of a media file. In one embodiment, the client consumption device 102 initially requests the file prefix and, in response to receipt of the file prefix, thereafter requests the content itself.

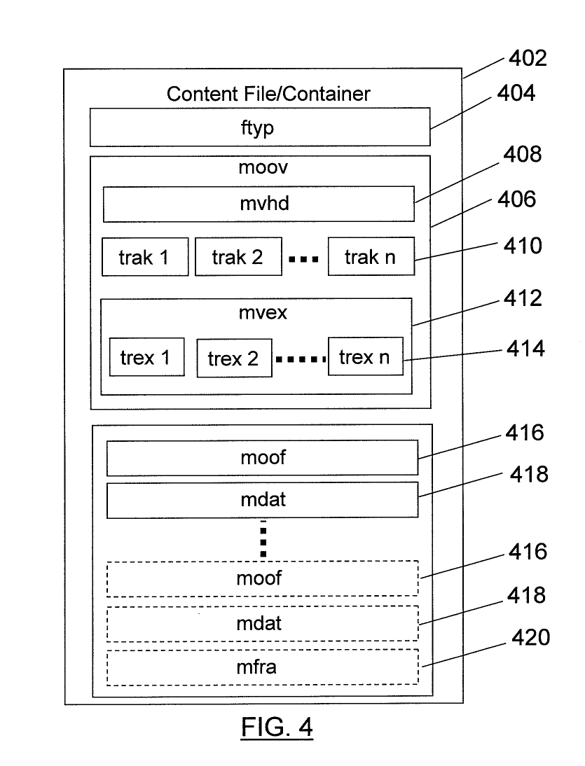

As shown in FIG. 4, for example, the content file or container 402 that is streamed from the server 104 to the content consumption device 102 may include a file prefix and a plurality of fragments that comprise the requested portion of the media file. In this regard, FIG. 4 illustrates ISOFF-compliant structured media content that may be formatted by the media streaming circuitry 128 in accordance with one example embodiment of the invention. It will be appreciated, however, that ISOFF-compliant media files are used for purposes of example and not by way of limitation. Further, the structure of the media content illustrated in FIG. 4 and described in respect thereto is for purposes of example and the structure may be arranged differently in accordance with other embodiments of the invention. Additionally, the media content of FIG. 4 is described with respect to movie content. However, it will be appreciated that embodiments of the invention may be applied to other types of media content as well, such as audio only media content, video only media content, and audio/video media content.

In the illustrated embodiment, the prefix need only be transmitted once and is comprised of the ftyp and moov boxes 404 and 406 with the ftyp box 404 indicating the brand and the version number of the media content. The moov box 406 of the embodiment includes the mvhd box 408, one or more trak boxes 410 and the mvex box 412 including one or more trex boxes 414. Notably, the moov box 406 does not include any sample descriptions, e.g., no stts, ctts, stsc, stsz, stco or stss boxes, and thus is relatively small in size. Instead, the moov box 406 includes only information that describes the structure of the file, the existing tracks, the track types and the sample descriptions. In this regard, each trak box 410 of the moov box 406 includes information about a media track in an IS OFF-compliant file including, for example, information about the location and size of the track, descriptive information and timing information. Further, the mvex box 412 and its trex boxes 414 of the illustrated embodiment indicate that the portion of the media file that is to be provided will consist of movie fragments with each trex box 414 providing default information that need not be repeated with each subsequent movie fragment.

Following the file prefix, a movie fragment box moof 416, the mdat box 418 and optionally the mfra box 420 that comprise the description and media samples of a respective movie fragment may be repeatedly provided with one set of the moof and mdat boxes being provided for each of the multiple fragments that comprise the requested portion of the media file. Following the provision of all fragments, that is, all moof and mdat boxes, an mfra box 418 may be optionally provided.

Regarding the request by the content consumption device 102 for the file prefix as shown in operation 306 of FIG. 3, the content consumption device 102 may issue a query to the server 104 for the file prefix including, for example, the ftyp and moov boxes 402 and 404. One example of a query to retrieve the file prefix that may be issued by the content consumption device 102 to the server 104 is GET http://www.nokia.com/httpstreaming.php?content=www.nokia.com/content/example.3gp&type=prefix HTTP/1.1 or in another example as follows: GET http://www.nokia.com/httpstreaming.php/example.3gp/prefix HTTP/1.1

In the first of the foregoing queries, the query parameter “content” may be utilized to refer to the desired content and is typically already included in the original HTTP URL, such as the example provided above. In addition, the query parameter “type” is used to indicate the type of the request. In this context in which the prefix is being requested, the value of the type parameter is set to “prefix”. In one embodiment, the type parameter may utilize the augmented backus-naur format (ABNF) syntax as follows: Type=“type=” [“prefix”|“media”|“description”]. In this embodiment, the value “media” may be utilized to indicate that the media data that is to be requested is in the form of movie fragment, while the value “description” is utilized to indicate that a section description is requested, such as a SPD file. Other values for the type parameter may be alternatively utilized in other embodiments.

In another embodiment as in the URL example “GET http://wwwnokia.com/httpstreaming.php/example.3gp/prefix HTTP/1.1”, the type parameter may follow the content parameter immediately, separated by a “/” character. In this instance, an identifier such as “type=” is not necessary as the URL will be constructed following a known patter and the server 104 is able to extract the type indication from the request URL.

Following the request for the prefix and the delivery of the prefix by the server 104, the content consumption device 102 may issue the transfer protocol request for a portion of the media file. In response and as shown in operations 308, 310 and 312 of FIG. 3, the server 104 may then stream the fragments that comprise the requested media file until the entirety of the requested portion of the media file has been delivered or until the user has otherwise aborted the streaming.

In the transfer protocol request, the content consumption device 102 may indicate the streaming protocol to be utilized during download of the requested portion of the media file. For example, the transfer protocol request may request that the selected portion of the media file be streamed via HTTP. Although the transfer protocol request identifies the portion of the media file to be streamed from the server 104, the transfer protocol request does not identify and request a single fragment. Instead, the transfer protocol request identifies a portion of a media file that may comprise, or may be formatted to comprise, a plurality of fragments.

The transfer protocol request issued by the content consumption device 102 may identify the portion of the media file to be streamed in various manners. In one embodiment, the transfer protocol request identify a start time and an ending time with the server 104 then streaming the portion of the media file, typically comprised of a plurality of fragments, that extends from the start time to the ending time. Alternatively, the transfer protocol request may identify a start time and a duration with the server 104 being configured to stream that portion of the media content that begins at the start time and that continues thereafter for the length of time identified by the duration. The content consumption device 102 may be configured to identify the portion of the media file to be streamed in other manners including, for example, a transfer protocol request that includes a number of frames and/or a number of scenes to be streamed with the frames and/or scenes generally being comprised of a plurality of fragments. Still further, the transfer protocol request issued by the content consumption device 102 of one embodiment may request the next piece or portion of the media file which, in turn, is interpreted by the server 104 as being that portion of the media file that is available at the time that the request is received. For example, the media file may be a recording of a live event such that a transfer protocol request issued by the client consumption device 102 for the next piece of the media file may trigger the streaming of that portion of the live broadcast that has been recorded up until the time at which the request is received by the server 104. Although various examples of the manner in which the content consumption device 102 may identify the portion of the media file to be streamed from the server 104 to the content consumption device 102, the content consumption device 102 may identify the portion of the media file to be streamed in other manners.

In one example, the content consumption device 102 may issue a GET request similar to the above-described GET request that is utilized to retrieve the file prefix, but which sets the type parameter to “media”. In one embodiment, the content consumption device 102 may also identify a subset of the available tracks for streaming with the transfer protocol request soliciting the streaming of each of the requested tracks, such as a plurality of different types of tracks. Relative to the foregoing example, the content consumption device 102 may only be interested in English language audio and video data at 300 kbps, thereby resulting in a selection of a subset of the available tracks to include track 1 and track 7. As illustrated in the example provided below, a “tracks” parameter may be included in the GET request to identify the requested tracks. Although the GET request does not identify a particular fragment to be streamed, the content consumption device 102 of one embodiment may indicate the time frame of the portion of the media file that is to be streamed from the server 104 to the content consumption device 102. In one embodiment, for example, a start time and a duration are provided that define the portion of the media file to be streamed. As noted above, however, the portion of the media file that is requested to be streamed may be identified in other manners. By way of illustration, but not of limitation, one example of an HTTP query issued by a content consumption device for media data is as follows: GET http://www.nokia.com/httpstreaming.php/example.3gp/media/1+7/23234/5/1/0 HTTP/1.1 or GET http://www.nokia.com/httpstreaming.php?content=www.nokia.com/content/example.3gp&type=media&tracks=1,7&ts=23.234&duration=5&fd=1&RAP=0 HTTP/1.1.

In addition to setting the type parameter to “media” and identifying tracks 1 and 7 to be streamed, the GET query includes a start time, e.g., “st”, of 23.234 which corresponds to the time stamp/playback time of the first fragment to be streamed by the server 104 to the content consumption device 102. The GET query of this example also includes a duration of 5 that indicates the total duration in media time of the portion of the media file to be streamed from the server 104. By defining a duration that encompasses multiple fragments, the number of requests that must be issued by the content consumption device 102 and responded to by the server 104 may be reduced, thereby reducing the request overhead and increasing the efficiency of the streaming process. In an alternative embodiment, the GET query may not include the duration parameter, but may, instead, include the end time “et” with the start and end times cooperating to define the window of time for which the requested portion of the media file is to be streamed. As also indicated in the foregoing example, the desired fragment duration “fd” may also be provided by the GET query. In one example, the fragment duration is in the range of one or more seconds, e.g., one second in the foregoing example, since a fragment is independently playable and, as such, may have a reasonable duration to limit the initial playback delay and maintain the overhead at a reasonable level. Further, the GET query may include a random access point “RAP” parameter. If the random access point parameter is set to 1, the resulting query may indicate that the content consumption device 102 is requesting that the first fragment of the response begin with a random access point in which case the actual start time may differ from the requested start time. Alternatively, if the random access point parameter is set to one as in the foregoing example, the first fragment of the response need to not start with a random access point and may, instead, begin at the requested start time, if the query has a requested start time as in the foregoing example.

Based upon the GET request, the server 104 may identify the fragments that comprise the requested portion of the media file and stream those fragments to the content consumption device 102. The server 104 may identify and retrieve the fragments from a stored file or set of files with prepared fragments, from a stored file or set of files without prepared fragments, e.g., a 3GP file or another file format, or from a live source. Since the content consumption device 102 is not requesting the streaming of content on a fragment-by-fragment basis based upon an index file that was previously provided by the server 104, but is, instead, requesting the streaming of a portion of a media file that may include multiple fragments, the server 104 may, but need not be constrained so as to have fragmented the media file prior to receipt of the request from the content consumption device 102. Instead, the server 104 may fragment the media file on the fly in response to the request from the content consumption device 102. By permitting the server 104 to fragment the requested portion of the media file in response to receipt of the request from the content consumption device 102, the server 104 may more readily stream portions of a media file that consist of a live recording or event since the live recording or event is incapable of having been fragmented in advance. Moreover, by permitting the server 104 to fragment the media file on the fly, the server 104 may reduce its storage requirements by only requiring storage of those fragments that are generated and not all possible track alternatives.

In regards to FIG. 3, for example, the server 104 may fragment the requested portion of the media file in response to receipt of the request from the content consumption device 102 and may then stream the content to the content consumption device 102, such as by repeatedly provide a sequence of moof and mdat boxes 416 and 418 and optionally an mfra box 420. In this regard, the mfra box 420 may delivered once at the end of each request, after each fragment or not at all. If delivered, the mfra box 420 includes information that indicates the time position of the samples in the fragments and, as such, may facilitate the playback of their requested portion of the media file.

As illustrated by the above example, a single request by a content consumption device 102 may include a request for different types of tracks, such as audio tracks, video tracks, subtitle tracks and the like. By permitting a single request to include a request different types of tracks, the number of requests that must be issued by the content consumption device 102 and separately responded to by the server 104 may be further reduced, thereby reducing the request overhead and increasing the efficiency of the streaming process.

Furthermore, the requested portion of the media file generally include multiple fragments and, therefore, extends over a longer period of time than conventional requests for a single fragment. As such, the content consumption device 102 may have a larger sampling window for determining the current network conditions, such as the bandwidth available to the content consumption device 102, and, as such, may be able to more accurately determine the corresponding bit rate for the requested portion of the media file. With respect to the foregoing example, a variety of different video tracks were available by the server 104 at different bit rates. Based upon the network conditions as determined by the content consumption device 102, the content consumption device 102 may request a video track having a particular bitrate that corresponds to the current network conditions. Since the requested portion of the media file encompasses multiple fragments, the content consumption device may not only be able to determine the network conditions with more reliability than prior determinations made on a fragment-by-fragment basis, but changes in the bit rate of the streamed video will change less frequently do, for example, to the increased lengths of the requested portion of the media file such that the resulting display of the media file to a user will appear smoother with less disconcerting changes in the bit rate.

In an alternative embodiment, the content consumption device 102 and the server 104 may utilize a chunked mode in which the content consumption device 102 may request an open-ended range of the media file, such as by omitting the duration or end time parameters in the query. In this embodiment, the server 104 may employ a chunked mode to encapsulate each fragment in a separate chunk without having to prepare the entirety of the requested portion of the media file a priori. In other words, the content consumption device 102 of this embodiment does not have to indicate the size of the response body when commencing streaming of their response. The chunked mode may also be appropriate for requested portions of a media file having relatively long durations which would otherwise require more extensive processing by the server 104 and potentially delay the streaming of the requested portion of the media file.

A relatively long streaming response from a server 104 may be interrupted by a content consumption device 102 by pipelining HTTP requests. In this situation, a subsequent request may be utilized by the server 104 to terminate a prior response before starting the response to the new request. In this regard, the server 104 may need to retain session information, such as by utilizing HTTP cookies. By retaining session information, the server 104 may be able to identify that the pipeline requests are related.

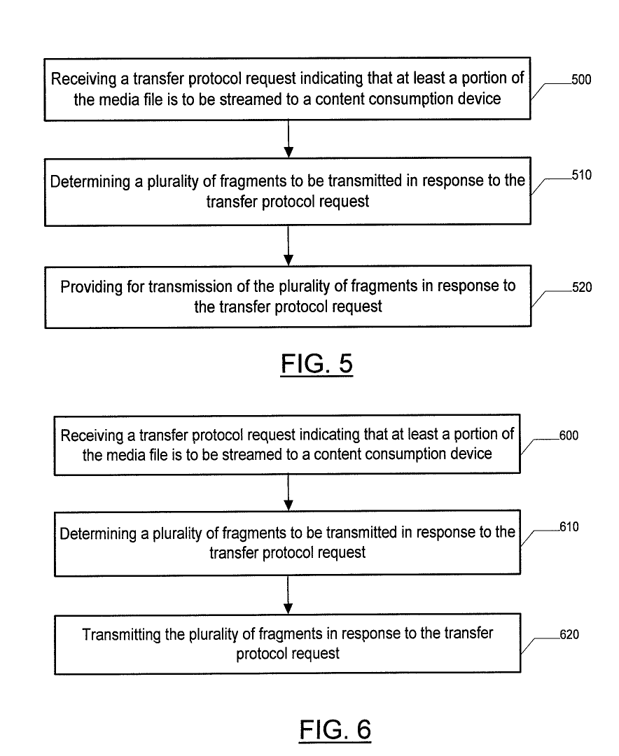

FIG. 5 illustrates a flowchart according to an exemplary method for the dynamic streaming of media files according to an exemplary embodiment of the present invention. In this regard, FIG. 5 illustrates operations that may be performed at the server 104. The operations illustrated in and described with respect to FIG. 5 may, for example, be performed by or under the control of the media streaming circuitry 128. Operation 500 comprises receiving a transfer protocol request for at least a portion of a media file. Pursuant to operation 502, a plurality of fragments that are to be transmitted to the content consumption device 102 based upon the transfer protocol request are then determined. Operation 504 then provides for the transmission of the plurality of fragments to the content consumption device 102 in response to the transfer protocol request.

FIG. 6 illustrates a flowchart according to an exemplary method for the dynamic streaming of media files according to an exemplary embodiment of the present invention. In this regard, FIG. 6 illustrates operations that may be performed by a server 104. One or more of the processor 120, memory 122, communication interface 124, user interface 126, or media streaming circuitry 128 may, for example, cause the server 104 to perform respective operations illustrated in and described with respect to FIG. 6. Operation 600 comprises receiving a transfer protocol request for at least a portion of a media file. Pursuant to operation 602, a plurality of fragments that are to be transmitted to the content consumption device 102 based upon the transfer protocol request are then determined. Operation 604 then transmits the plurality of fragments to the content consumption device 102 in response to the transfer protocol request.

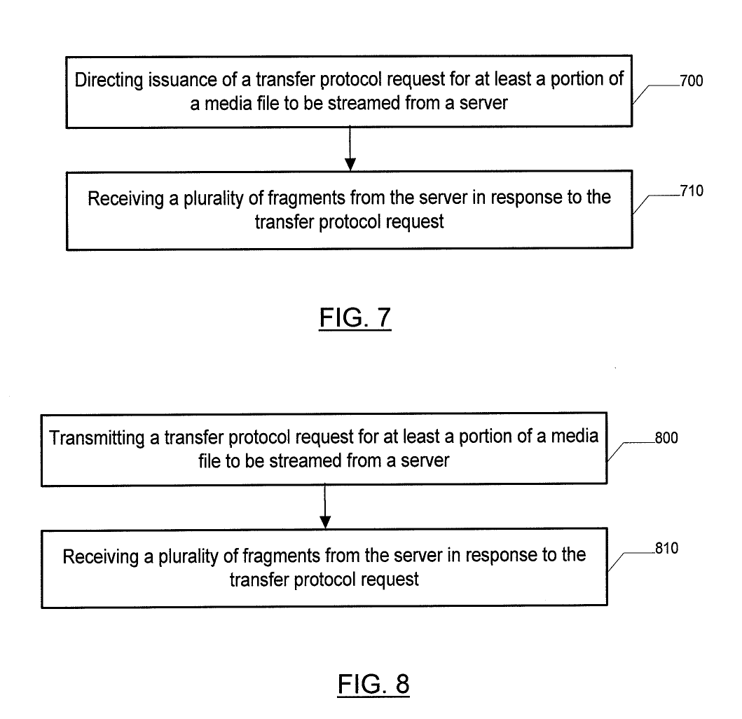

FIG. 7 illustrates a flowchart according to an exemplary method for the dynamic streaming of media files according to an exemplary embodiment of the present invention. In this regard, FIG. 7 illustrates operations that may be performed at the content consumption device 102. The operations illustrated in and described with respect to FIG. 7 may, for example, be performed by or under the control of the media playback circuitry 118. Operation 700 comprises directing issuance of a transfer protocol request for at least a portion of a media file. Thereafter, at operation 702, a plurality of fragments are received from the server 104 in response to the transfer protocol request.

FIG. 8 illustrates a flowchart according to an exemplary method for the dynamic streaming of media files according to an exemplary embodiment of the present invention. In this regard, FIG. 8 illustrates operations that may be performed by a content consumption device 102. One or more of the processor 110, memory 112, communication interface 114, user interface 116, or media playback circuitry 118 may, for example, cause the content consumption device 102 to perform respective operations illustrated in and described with respect to FIG. 8. Operation 800 comprises transmitting a transfer protocol request for at least a portion of a media file. Thereafter, at operation 802, a plurality of fragments are received from the server 104 in response to the transfer protocol request.

FIGS. 3 and 5-8 are a flowchart of a system, method, and computer program product according to exemplary embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor (e.g., processor 110 or processor 120) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., a content consumption device 102 and/or a server 104) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In a first example embodiment, a method is provided, which includes receiving a transport protocol request for at least the portion of the media file indicating that at least a portion of the media file is to be streamed to a content consumption device requesting the media file. The method of this embodiment also determines a plurality of fragments to be transmitted to the content consumption device based upon the transfer protocol request and then provides for transmission of the plurality of fragments to the content consumption device in response to the transfer protocol request.

The transport protocol request may identify the portion of the media file to be streamed in various manners, such as by identifying a time interval, identifying at least one scene or identifying a plurality of frames. In one embodiment, the transfer protocol request may identify different types of tracks such that the method of this embodiment provides for the transmission of a plurality of fragments which may, for example, contain multiplexed media data from each of the different types of tracks. The method of one embodiment also creates a plurality of fragments, such as by formatting at least the portion of the media file into a plurality of fragments, in response to the transfer protocol request, thereby supporting dynamic media file streaming and avoiding requirements to have fragmented the media file in advance of the transport protocol request. Alternatively, the method of another embodiment identifies a plurality of fragments from among a plurality of predefined fragments in response to the transfer protocol request.

In a second example embodiment a computer program product is provided. The computer program product includes at least one computer-readable storage medium having computer-readable program instructions stored therein. The computer-readable program instructions of this embodiment may include program instructions which, when executed by a processor, are configured to receive a transport protocol request for at least the portion of the media file indicating that at least a portion of the media file is to be streamed to a content consumption device requesting the media file. The computer-readable program instructions of this embodiment are also configured, when executed by a processor, to determine a plurality of fragments to be transmitted to the content consumption device based upon the transfer protocol request and to then provide for transmission of the plurality of fragments to the content consumption device in response to the transfer protocol request.

The transport protocol request may identify the portion of the media file to be streamed in various manners, such as by identifying a time interval, identifying at least one scene or identifying a plurality of frames. In one embodiment, the transfer protocol request may identify different types of tracks such that the method of this embodiment provides for the transmission of a plurality of fragments containing, for example, multiplexed media data of each of the different types of tracks. The computer-readable program instructions of one embodiment are also configured, when executed by a processor, to create a plurality of fragments, such as by formatting at least the portion of the media file into a plurality of fragments, in response to the transfer protocol request, thereby supporting dynamic media file streaming and avoiding requirements to have fragmented the media file in advance of the transport protocol request. Alternatively, the computer-readable program instructions of another embodiment are configured, when executed by a processor, to identify a plurality of fragments from among a plurality of predefined fragments in response to the transfer protocol request.

In a third example embodiment, an apparatus is provided. The apparatus of this embodiment includes at least one processor and at least one memory storing computer program code. The at least one memory storing computer program code is configured to, working with the at least one processor, cause the apparatus to receive a transport protocol request for at least the portion of the media file indicating that at least a portion of the media file is to be streamed to a content consumption device requesting the media file. The apparatus of this embodiment is also caused to determine a plurality of fragments to be transmitted to the content consumption device based upon the transfer protocol request and to then provide for transmission of the plurality of fragments to the content consumption device in response to the transfer protocol request.

The transport protocol request may identify the portion of the media file to be streamed in various manners, such as by identifying a time interval, identifying at least one scene or identifying a plurality of frames. In one embodiment, the transfer protocol request may identify different types of tracks such that the method of this embodiment provides for the transmission of a plurality of fragments containing, for example, multiplexed media data of each of the different types of tracks. The apparatus of one embodiment is also configured to create a plurality of fragments, such as by formatting at least the portion of the media file into a plurality of fragments, in response to the transfer protocol request, thereby supporting dynamic media file streaming and avoiding requirements to have fragmented the media file in advance of the transport protocol request. Alternatively, the apparatus of another embodiment is configured to identify a plurality of fragments from among a plurality of predefined fragments in response to the transfer protocol request.

The apparatus of this embodiment may be embodied as or may be embodied on a terminal. The apparatus of this embodiment may comprise a mobile phone further comprising user interface circuitry and user interface software stored on one or more of the at least one memory. The user interface circuitry and user interface software may be configured to facilitate user control of at least some functions of the mobile phone through use of a display. The user interface circuitry and user interface software may be further configured to cause at least a portion of a user interface of the mobile phone to be displayed on the display to facilitate user control of at least some functions of the mobile phone.

In a fourth example embodiment, an apparatus is provided that includes means for receiving a transport protocol request for at least the portion of the media file indicating that at least a portion of the media file is to be streamed to a content consumption device requesting the media file. The apparatus of this embodiment also includes means for determining a plurality of fragments to be transmitted to the content consumption device based upon the transfer protocol request and means for providing for transmission of the plurality of fragments to the content consumption device in response to the transfer protocol request.

The transport protocol request may identify the portion of the media file to be streamed in various manners, such as by identifying a time interval, identifying at least one scene or identifying a plurality of frames. In one embodiment, the transfer protocol request may identify different types of tracks such that the method of this embodiment provides for the transmission of a plurality of fragments containing, for example, multiplexed media data of each of the different types of tracks. The apparatus of one embodiment also includes means for creating a plurality of fragments, such as by formatting at least the portion of the media file into a plurality of fragments, in response to the transfer protocol request, thereby supporting dynamic media file streaming and avoiding requirements to have fragmented the media file in advance of the transport protocol request. Alternatively, the apparatus of another embodiment includes means for identifying a plurality of fragments from among a plurality of predefined fragments in response to the transfer protocol request.

In a fifth example embodiment, a method is provided, which includes directing issuance of a transfer protocol request for at least a portion of the media file indicating that at least a portion of the media file is to be streamed from a server. A method of this embodiment also receives a plurality of fragments from the server in response to the transfer protocol request.

The transport protocol request may identify the portion of the media file to be streamed in various manners, such as by identifying a time interval, identifying at least one scene or identifying a plurality of frames. In one embodiment, the issuance of the transfer protocol request includes the identification of different types of tracks to be streamed. As such, in this embodiment, the receipt of the plurality of fragments will include receiving the plurality of fragments of each of the different types of tracks.

In a sixth example embodiment a computer program product is provided. The computer program product includes at least one computer-readable storage medium having computer-readable program instructions stored therein. The computer-readable program instructions of this embodiment may include program instructions which, when executed by a processor, are configured to direct issuance of a transfer protocol request for at least a portion of the media file indicating that at least a portion of the media file is to be streamed from a server. The computer-readable program instructions of this embodiment are also configured, when executed by a processor, to receive a plurality of fragments from the server in response to the transfer protocol request.

The transport protocol request may identify the portion of the media file to be streamed in various manners, such as by identifying a time interval, identifying at least one scene or identifying a plurality of frames. In one embodiment, the issuance of the transfer protocol request includes the identification of different types of tracks to be streamed. As such, in this embodiment, the receipt of the plurality of fragments will include receiving the plurality of fragments of each of the different types of tracks.

In a seventh example embodiment, an apparatus is provided. The apparatus of this embodiment includes at least one processor and at least one memory storing computer program code. The at least one memory storing computer program code is configured to, working with the at least one processor, cause the apparatus to direct issuance of a transfer protocol request for at least a portion of the media file indicating that at least a portion of the media file is to be streamed from a server. The apparatus of this embodiment is also caused to receive a plurality of fragments from the server in response to the transfer protocol request.

The transport protocol request may identify the portion of the media file to be streamed in various manners, such as by identifying a time interval, identifying at least one scene or identifying a plurality of frames. In one embodiment, the issuance of the transfer protocol request includes the identification of different types of tracks to be streamed. As such, in this embodiment, the receipt of the plurality of fragments will include receiving the plurality of fragments of each of the different types of tracks.

The apparatus of this embodiment may be embodied as or may be embodied on a terminal. The apparatus of this embodiment may comprise a mobile phone further comprising user interface circuitry and user interface software stored on one or more of the at least one memory. The user interface circuitry and user interface software may be configured to facilitate user control of at least some functions of the mobile phone through use of a display. The user interface circuitry and user interface software may be further configured to cause at least a portion of a user interface of the mobile phone to be displayed on the display to facilitate user control of at least some functions of the mobile phone.

In an eighth example embodiment, an apparatus is provided that includes means for directing issuance of a transfer protocol request for at least a portion of the media file indicating that at least a portion of the media file is to be streamed from a server. The apparatus of this embodiment also includes means for receiving a plurality of fragments from the server in response to the transfer protocol request.

The transport protocol request may identify the portion of the media file to be streamed in various manners, such as by identifying a time interval, identifying at least one scene or identifying a plurality of frames. In one embodiment, the issuance of the transfer protocol request includes the identification of different types of tracks to be streamed. As such, in this embodiment, the receipt of the plurality of fragments will include receiving the plurality of fragments of each of the different types of tracks.

In a further embodiment, a system is provided that includes a server and a content consumption device configured to support media file streaming from the server to the content consumption device. In this embodiment, the content consumption device is configured to direct issuance of a transfer protocol request for at least a portion of the media file indicating that at least a portion of the media file is to be streamed from a server and to receive a plurality of fragments from the server in response to the transfer protocol request. In addition, the server in this embodiment is configured to receive a transport protocol for at least the portion of the media file indicating that at least a portion of the media file is to be streamed to a content consumption device requesting the media file. The server of this embodiment is also caused to determine a plurality of fragments to be transmitted to the content consumption device based upon the transfer protocol request and to then provide for transmission of the plurality of fragments to the content consumption device in response to the transfer protocol request.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving a transport protocol request for at least a portion of a media file indicating that at least the portion of the media file is to be streamed to a content consumption device requesting the media file;
determining, via a processor, a plurality of fragments to be transmitted to the content consumption device based upon the transfer protocol request; and
providing for transmission of the plurality of fragments to the content consumption device in response to the transfer protocol request.

2. A method according to claim 1 wherein receiving the transport protocol request comprises receiving the transport protocol request that identifies the portion of the media file to be streamed by at least one of identifying a time interval, identifying at least one scene or identifying a plurality of frames.

3. A method according to claim 1 wherein receiving the transport protocol request comprises receiving the transfer protocol request that identifies different types of tracks, and wherein providing for transmission of the plurality of fragments comprises providing for transmission a plurality of fragments of each of the different types of tracks.

4. A method according to claim 3 wherein providing for transmission of the plurality of fragments comprises providing for transmission of a plurality of fragments that contain multiplexed media data from each of the different types of tracks.

5. A method according to claim 1 further comprising formatting at least the portion of the media file into a plurality of fragments in response to the transfer protocol request.

6. A computer program product comprising at least one computer-readable storage medium having computer-executable program code instructions stored therein that, upon execution by the processor, cause performance of the method of claim 1.

7. An apparatus comprising at least one processor and at least one memory storing computer program code, the at least one memory and the computer program code configured to, with the at least one processor, cause the apparatus to:
receive a transport protocol request for at least a portion of a media file indicating that at least the portion of the media file is to be streamed to a content consumption device requesting the media file;
determine a plurality of fragments to be transmitted to the content consumption device based upon the transfer protocol request; and
provide for transmission of the plurality of fragments to the content consumption device in response to the transfer protocol request.

8. An apparatus according to claim 7 wherein the at least one memory and the computer program code are configured to, with the at least one processor, cause the apparatus to receive the transport protocol request by receiving the transport protocol request that identifies the portion of the media file to be streamed by at least one of identifying a time interval, identifying at least one scene or identifying a plurality of frames.

9. An apparatus according to claim 7 wherein the at least one memory and the computer program code are configured to, with the at least one processor, cause the apparatus to receive the transport protocol request by receiving the transfer protocol request that identifies different types of tracks, and to provide for transmission of the plurality of fragments by providing for transmission a plurality of fragments of each of the different types of tracks.

10. An apparatus according to claim 9 wherein the at least one memory and the computer program code are configured to, with the at least one processor, cause the apparatus to provide for transmission of the plurality of fragments by providing for transmission of a plurality of fragments that contain multiplexed media data from each of the different types of tracks.

11. An apparatus according to claim 7 wherein the at least one memory and the computer program code are configured to, with the at least one processor, further cause the apparatus to format at least the portion of the media file into a plurality of fragments in response to the transfer protocol request.

12. A method comprising:
directing, via a processor, issuance of a transfer protocol request for at least a portion of a media file indicating that at least a portion of the media file is to be streamed from a server; and
receiving a plurality of fragments from the server in response to the transfer protocol request.

13. A method according to claim 12 wherein directing issuance of the transfer protocol request comprises directing issuance the transport protocol request that identifies the portion of the media file to be streamed by at least one of identifying a time interval, identifying at least one scene or identifying a plurality of frames.

14. A method according to claim 12 wherein directing issuance of the transfer protocol request comprises directing issuance of the transfer protocol request that includes an identification of different types of tracks to be streamed, and wherein receiving the plurality of fragments comprises receiving the plurality of fragments of each of the different types of tracks.

15. A method according to claim 12 wherein directing issuance of the transfer protocol request comprises directing issuance of the transfer protocol request including an identification of a protocol via which the media file is to be streamed.

16. A computer program product comprising at least one computer-readable storage medium having computer-executable program code instructions stored therein that, upon execution by the processor, cause performance of the method of claim 12.

17. An apparatus comprising at least one processor and at least one memory storing computer program code, the at least one memory and the computer program code configured to, with the at least one processor, cause the apparatus to:
direct issuance of a transfer protocol request for at least a portion of a media file indicating that at least a portion of the media file is to be streamed from a server; and
receive a plurality of fragments from the server in response to the transfer protocol request.

18. An apparatus according to claim 17 wherein the at least one memory and the computer program code are configured to, with the at least one processor, cause the apparatus to direct issuance of the transfer protocol request by directing issuance the transport protocol request that identifies the portion of the media file to be streamed by at least one of identifying a time interval, identifying at least one scene or identifying a plurality of frames.

19. An apparatus according to claim 17 wherein the at least one memory and the computer program code are configured to, with the at least one processor, cause the apparatus to direct issuance of the transfer protocol request by directing issuance of the transfer protocol request that includes an identification of different types of tracks to be streamed, and to receive the plurality of fragments by receiving the plurality of fragments of each of the different types of tracks.

20. An apparatus according to claim 17 wherein the at least one memory and the computer program code are configured to, with the at least one processor, cause the apparatus to direct issuance of the transfer protocol request by directing issuance of the transfer protocol request including an identification of a protocol via which the media file is to be streamed.
